(19) United States
(12) Patent Application Publication
(10) Pub. No.: US 2026/0098629 A1
(43) Pub. Date: Apr. 9, 2026

(54) FOLDING ELONGATE LIGHTING FIXTURE

(71) Applicant: RAB Lighting Inc., New York, NY (US)

(72) Inventors: Jose Quinones, Pearland, TX (US); Peter On, Henderson, NV (US); Glen Oross, Heber City, UT (US); Stephen Osborne, Glen Arm, MD (US); Wengang Gao, Ningbo (CN); Thomas Holscher, Greenville, SC (US)

(21) Appl. No.: 18/910,900

(22) Filed: Oct. 9, 2024

(51) Int. Cl. F21V 21/30; F21S 4/28

(52) U.S. Cl. CPC F21V 21/30; F21S 4/28

(57) ABSTRACT

An illustrative elongate lighting fixture comprises a first fixture portion including a first lens and a first support, a second fixture portion including a second lens and a second support, and a hinge coupling the first support to the second support for movement of the first and second fixture portions between a folded position and an extended position. In the folded position used for packaging, transport, and storage, the first fixture portion overlies the second fixture portion and the first and second fixture portions remain coupled by the hinge. In the extended position for installation a first joining end of the first lens abuts a second joining end of the second lens to form a continuous illumination surface and the hinge is concealed by the first and second fixture portions.

### TECHNICAL FIELD

Embodiments of this disclosure relate generally to lighting fixtures, also known as luminaires, and more particularly to lighting fixtures that may be reduced in size for packaging, transport, and storage, and expanded in size upon installation.

### BACKGROUND

Standard strip lighting fixtures for commercial and industrial applications, including for ceiling and hanging mounting, are commonly available in 4-foot and 8-foot lengths. It was realized by the inventors of the current disclosure that problems exist with packaging, transport, and storage of lighting fixtures having a dimension greater than 4-feet. The shorter 4-feet length fixtures can be easily packaged and shipped using a standard pallet size, which has a maximum dimension of 4-feet and most generally measures 48-inches by 40-inches. Fixtures having a dimension greater than 4-feet, including 8-feet-long strip lighting fixtures, require a larger non-standard pallet size or non-palletized shipping, either of which can incur much higher shipping costs particularly for inventory or other bulk quantity orders. Additionally, packaging, transport, and storage of a light fixture greater than 4-feet in length is more difficult and increases the risk of damage to the fixture prior to installation. Also, carrying a light fixture greater than 4-feet in length up a ladder or in a high lift bucket can be cumbersome. While some extendable light fixtures are known, they require partial assembly/disassembly, insertion/removal of lighting elements such as emitters and lenses, and/or coupling/decoupling of wiring to change between a shortened and lengthened configuration.

Certain features of the present disclosure address these and other needs and provide other important advantages over prior light fixtures that exceed 4-feet in length.

### SUMMARY

Embodiments of the present disclosure provide an elongate lighting fixture comprises a first fixture portion including a first lens and a first support, a second fixture portion including a second lens and a second support, and a hinge coupling the first support to the second support for movement of the first and second fixture portions between a folded position and an extended position. In the folded position used for packaging, transport, and storage, the first fixture portion overlies the second fixture portion and the first and second fixture portions remain coupled by the hinge. In the extended position for installation a first joining end of the first lens abuts a second joining end of the second lens to form a continuous illumination surface and the hinge is concealed by the first and second fixture portions.

In accordance with a first aspect of embodiments of the present disclosure, an elongate lighting fixture can include: a first fixture portion including a first plurality of light emitters and a first lens covering the first plurality of light emitters; a second fixture portion including a second plurality of light emitters and a second lens covering the second plurality of light emitters; and a hinge assembly rotatably coupling the first and second fixture portions for movement between a folded position and an extended position; and wherein: the first fixture portion defines a first joining end adjacent the hinge assembly; the second fixture portion defines a second joining end adjacent the hinge assembly; in the folded position the first fixture portion overlies the second fixture portion and the first and second fixture portions remain coupled by the hinge assembly; and in the extended position the first joining end abuts the second joining end and the hinge assembly is concealed by the first and second fixture portions.

Additionally, the first fixture portion can define a first top surface on a side opposite the first lens; the second fixture portion can define a second top surface on a side opposite the second lens; and in the folded position the first top surface can abut the second top surface. Also, in the extended position the first lens can be coplanar with the second lens. Further in the extended position, the first lens and the second lens can form a continuous illumination surface, a first joining end of the first lens can be optically transmissive and abut a second joining end of the second lens that also can be optically transmissive.

Also, the first lens can include a gap diffuser at the first joining end; in the extended position a first portion of the gap diffuser can abut the second joining end of the second lens; in the extended position a second portion of the gap diffuser can overlap the second joining end of the second lens.

Further, the hinge assembly can include: a first support coupled to the first fixture portion; a second support coupled to the second fixture portion; and at least one hinge coupling the first support to the second support. Additionally, the first support can define a first hinge mortise; the second support can define a second hinge mortise; and the at least one hinge can include a barrel mortise hinge anchored within the first hinge mortise and the second hinge mortise.

Additionally, the light fixture can be configured to enable locking the first and second housing portions in the extended position, and the hinge assembly can be configured to enable locking the hinge assembly thereby fixing the first and second fixture portions in the extended position. Also, the hinge assembly can include: a first support coupled to the first fixture portion; a second support coupled to the second fixture portion; and a brace releasably coupled to at least one of the first support and the second support to lock the hinge assembly. Furthermore, the first support can define a first receiver; the second support can define a second receiver; and the brace can be received by the first receiver and the second receiver to lock the hinge assembly.

Further, the first fixture portion can include a first upper housing and a first lower housing; the second fixture portion can include a second upper housing and a second lower housing; the hinge assembly can be coupled to the first and second upper housings; and the first and second lower housings can include the respective first and second pluralities of light emitters and the respective first and second lenses.

Also, the first fixture portion can include a first housing hinge rotatably coupling the first lower housing to the first upper housing; and the second fixture portion can include a second housing hinge rotatably coupling the second lower housing to the second upper housing; and at least one of the first and second lower housings can be rotated to an open position relative to the first and second upper housings to provide access to lock the hinge assembly, and thereby retain the first and second fixture portions in the extended position.

In accordance with another aspect of embodiments of the present disclosure, an elongate lighting fixture, can include: a first fixture portion including a first plurality of light emitters and a first lens covering the first plurality of light emitters; a second fixture portion including a second plurality of light emitters and a second lens covering the second plurality of light emitters; and a hinge assembly rotatably coupling the first and second fixture portions for movement between a folded position and an extended position; and wherein: the first fixture portion can define a first top surface on a side opposite the first lens and can further define a first joining end adjacent the hinge assembly; the second fixture portion can define a second top surface on a side opposite the second lens and can further define a second joining end adjacent the hinge assembly; in the folded position the first top surface can overlie the second top surface and the first and second fixture portions can remain coupled by the hinge assembly; and in the extended position a first joining end of the first lens can abut a second joining end of the second lens to form a continuous illumination surface.

Additionally, in the extended position the hinge assembly can be concealed by the first and second fixture portions, the first lens can include a gap diffuser at the first joining end; and in the extended position a first portion of the gap diffuser can abut the second joining end of the second lens.

Also, the hinge assembly can be configured to enable locking the hinge assembly thereby fixing the first and second fixture portions in the extended position, and the hinge assembly can include: a first support coupled to the first fixture portion; a second support coupled to the second fixture portion; and at least one hinge coupling the first support to the second support. Further, the at least one hinge can be a barrel mortise hinge, and the hinge assembly can includes a brace releasably coupled to at least one of the first support and the second support to lock the hinge assembly.

In accordance with yet another aspect of embodiments of the present disclosure, an elongate lighting fixture can include: a first fixture portion including a first plurality of light emitters and a first lens covering the first plurality of light emitters; a second fixture portion including a second plurality of light emitters and a second lens covering the second plurality of light emitters; and a first support coupled to the first fixture portion; a second support coupled to the second fixture portion; and at least one hinge coupling the first support to the second support for movement of the first and second fixture portions between a folded position and an extended position; and wherein: in the folded position the first fixture portion can overlie the second fixture portion and the first and second fixture portions can remain coupled by the at least one hinge; and in the extended position a first joining end of the first lens can abut a second joining end of the second lens. Additionally, at least one hinge can be concealed by the first and second fixture portions.

This summary is provided to introduce a selection of the concepts that are described in further detail in the detailed description and drawings contained herein. This summary is not intended to identify any primary or essential features of the subject matter. Some or all of the described features may be present in the corresponding independent or dependent claims, but should not be construed to be a limitation unless expressly recited in a particular claim. Each embodiment described herein does not necessarily address every object described herein, and each embodiment does not necessarily include each feature described. Other forms, embodiments, objects, advantages, benefits, features, and aspects of the present disclosure will become apparent to one of skill in the art from the detailed description and drawings contained herein. Moreover, the various apparatuses described in this summary section, as well as elsewhere in this application, can be expressed as a large number of different combinations and subcombinations. All such useful, novel, and inventive combinations and subcombinations are contemplated herein, it being recognized that the explicit expression of each of these combinations is unnecessary.

### BRIEF DESCRIPTION OF THE DRAWINGS

Some of the figures shown herein may include dimensional proportions; however, such dimensions, proportions, and/or the relative scaling within the figures, are by way of example, and not to be construed as limiting except as recited in the detailed description or claims.

FIG. 1 is a rear perspective view of a first illustrative embodiment of an elongate lighting fixture shown in a folded position according to the instant disclosure;

FIG. 2 is an enlarged perspective view of a portion of the lighting fixture of FIG. 1;

FIG. 3 is a rear perspective view of the lighting fixture of FIG. 1 shown in a transit position between the folded position and an extended position;

FIG. 4 is a rear perspective view of the lighting fixture of FIG. 1 shown in an extended position;

FIG. 5 illustrates a central portion of the lighting fixture of FIG. 1 shown with first and second lower housings in an open position and the hinge assembly unlocked;

FIG. 6 illustrates the central portion of the lighting fixture of FIG. 1 shown in FIG. 5 with the hinge assembly locked;

FIG. 7 is a cross-sectional view of the lighting fixture of FIG. 1 taken along sectional cutting plane line 7-7, shown in FIG. 12;

FIG. 8 is the hinge of the lighting fixture of FIG. 1 shown in the folded position of the lighting fixture;

FIG. 9 is the hinge of FIG. 8 shown in a first transit position;

FIG. 10 is the hinge of FIG. 8 shown in a second transit position;

FIG. 11 is the hinge of FIG. 8 shown in the extended position of the lighting fixture;

FIG. 12 is a front perspective view of the lighting fixture of FIG. 1 shown in an extended position and with hanging hooks installed;

FIG. 13 is a cross-sectional view of a first end of the lighting fixture of FIG. 1 taken along sectional cutting plane line 13-13, shown in FIG. 12;

FIG. 14 is a cross-sectional view of a second end of the lighting fixture of FIG. 1 taken along sectional cutting plane line 14-14, shown in FIG. 12; and

FIG. 15 is an enlarged view of a portion of a second illustrative embodiment of an elongate lighting fixture according to the instant disclosure, the enlarged view illustrating the same enlarged portion as that shown in FIG. 2 for the first illustrative embodiment of FIG. 1.

### DETAILED DESCRIPTION OF THE ILLUSTRATED EMBODIMENTS

For the purposes of promoting an understanding of the principles of the disclosure, reference will now be made to one or more embodiments, which may or may not be illustrated in the drawings, and specific language will be used to describe the same. It will nevertheless be understood that no limitation of the scope of the disclosure is thereby intended; any alterations and further modifications of the described or illustrated embodiments, and any further applications of the principles of the disclosure as illustrated herein are contemplated as would normally occur to one skilled in the art to which the disclosure relates. At least one embodiment of the disclosure is shown in great detail, although it will be apparent to those skilled in the relevant art that some features or some combinations of features may not be shown for the sake of clarity.

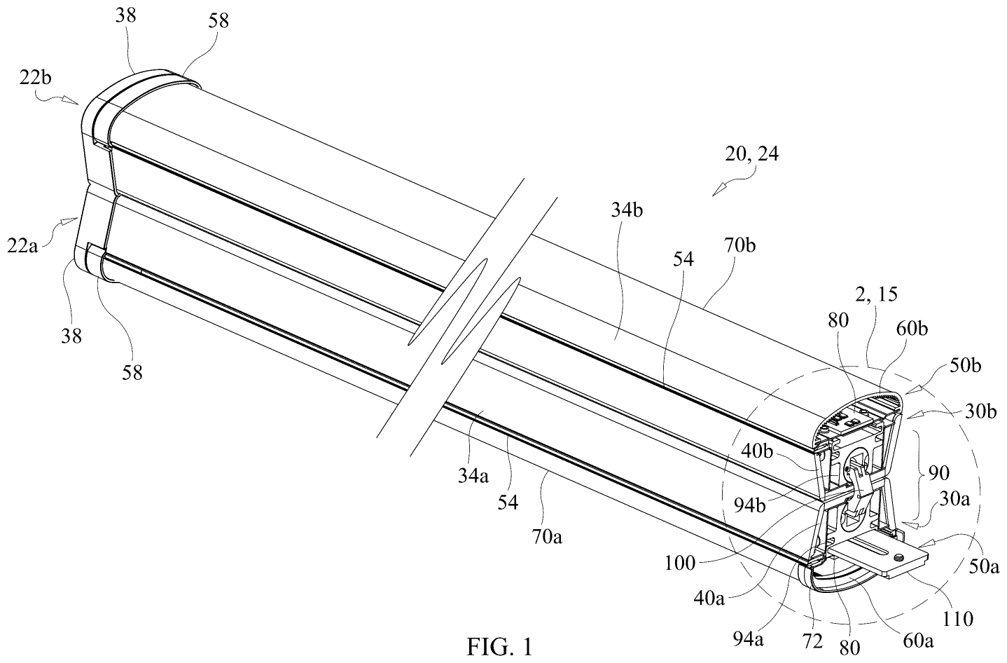

Referring to FIG. 1, a first illustrative embodiment of an elongate lighting fixture 20 is shown in a folded position 24 according to the present disclosure. The lighting fixture 20 includes a first fixture portion 22a and a second fixture portion 22b that may be equal or unequal lengths. Advantageously, the first and second fixture portions 22a/b are rotatably coupled by a hinge assembly 90. In the folded position 24, the second fixture portion 22b overlies the first fixture portion 22a and the first and second fixture portions remain coupled by the hinge assembly.

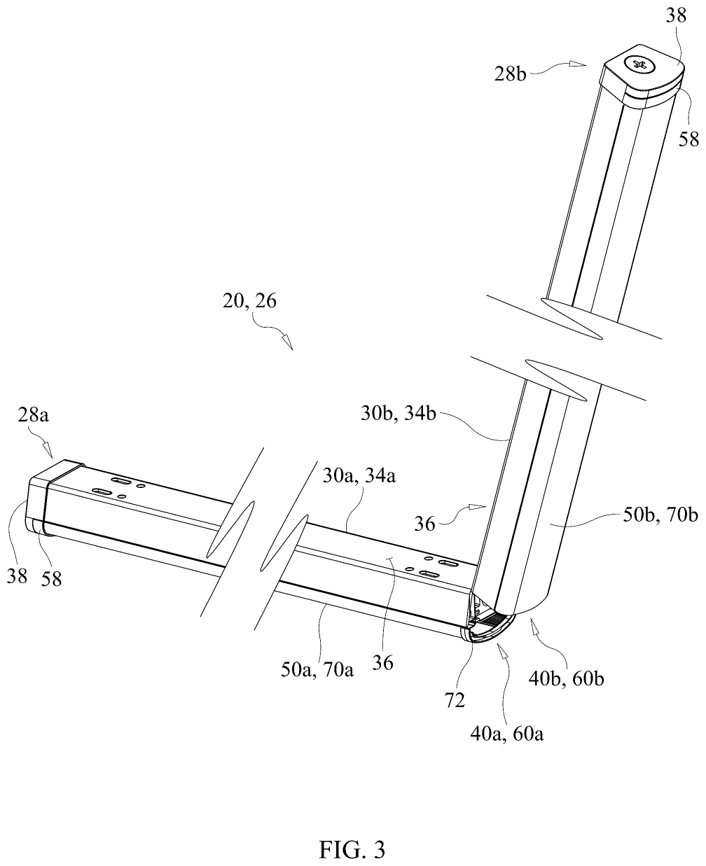

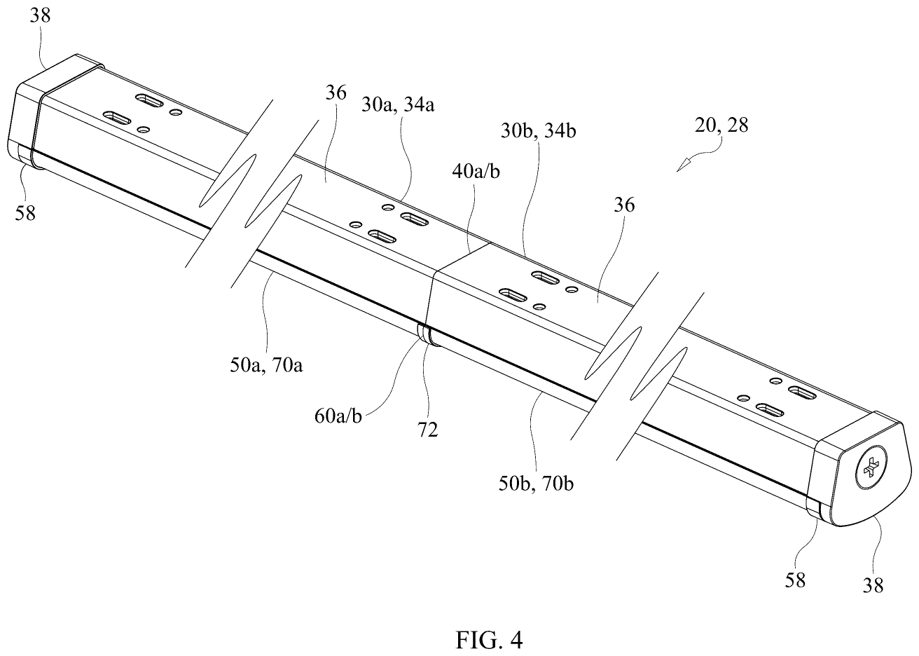

As can be understood by comparing FIG. 1 with FIG. 3, which illustrates the lighting fixture 20 in a transit position 26, and with FIG. 4, which illustrates the lighting fixture 20 in an extended position 28, the hinge assembly 90 enables the lighting fixture 20 to be packaged, shipped, and stored in the folded position 24, greatly reducing the largest dimension, for example, reducing the length by one-half, and then can be repositioned to the extended position 28 prior to installation. Advantageously, the hinge assembly 90 includes features that fully align and lock into position the first fixture portion 22a and the second fixture portion 22b, as will be discussed further below. Additionally, in the extended position 28, the hinge assembly 90 is completely concealed from view as it is fully contained within the first and second fixture portions 22a/b. By concealing the hinge assembly 90, the light fixture 20 is visually aesthetically improved and the hinge assembly is protected from dust, liquid spray, and other potential foreign matter that may be present in the installation location and may impact the function of the hinge assembly.

By providing this folding feature, the elongate lighting fixture 20, for example, a strip light, can be reduced from a typical length of 8-feet to only 4-feet in length, which reduces costs and risk of damage and improves ease of handling in packaging, shipping, and storage. The folded position 22 may also be used for improved ease of handling of the light fixture 20 when ascending to a ceiling installation location via a ladder or a high lift bucket.

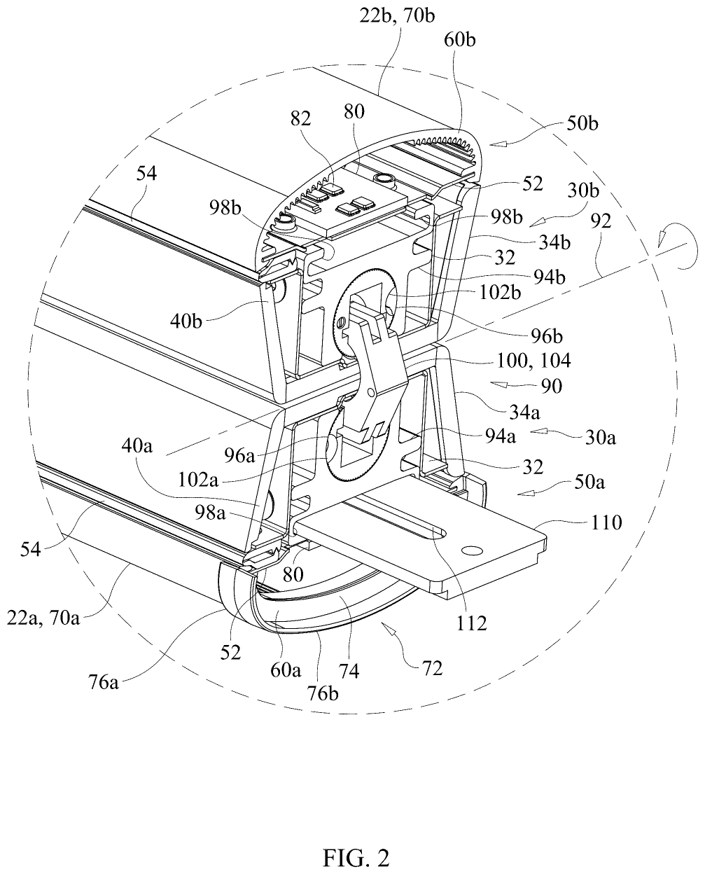

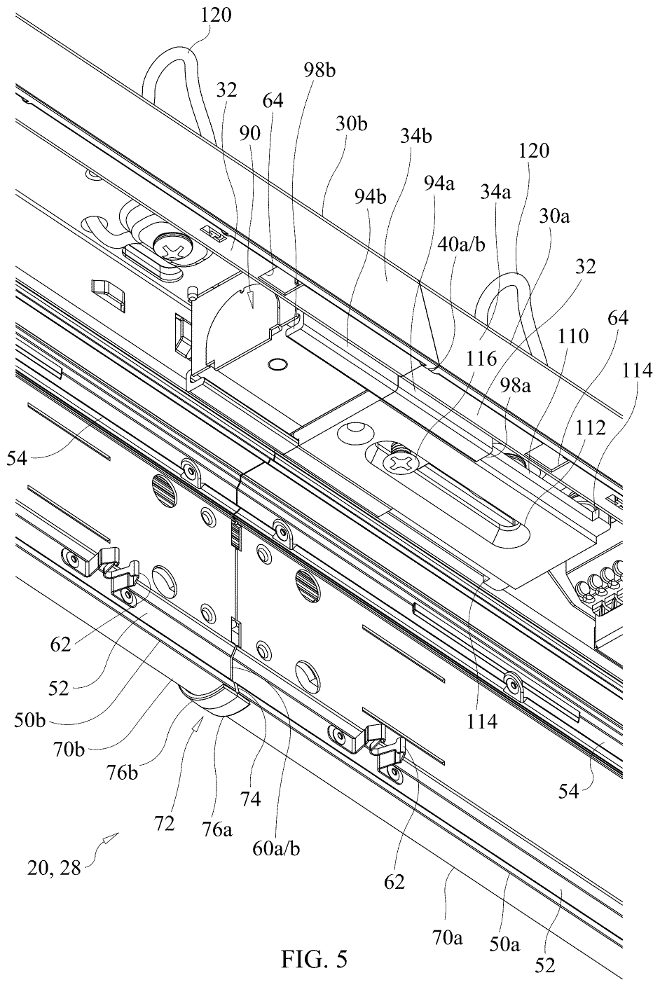

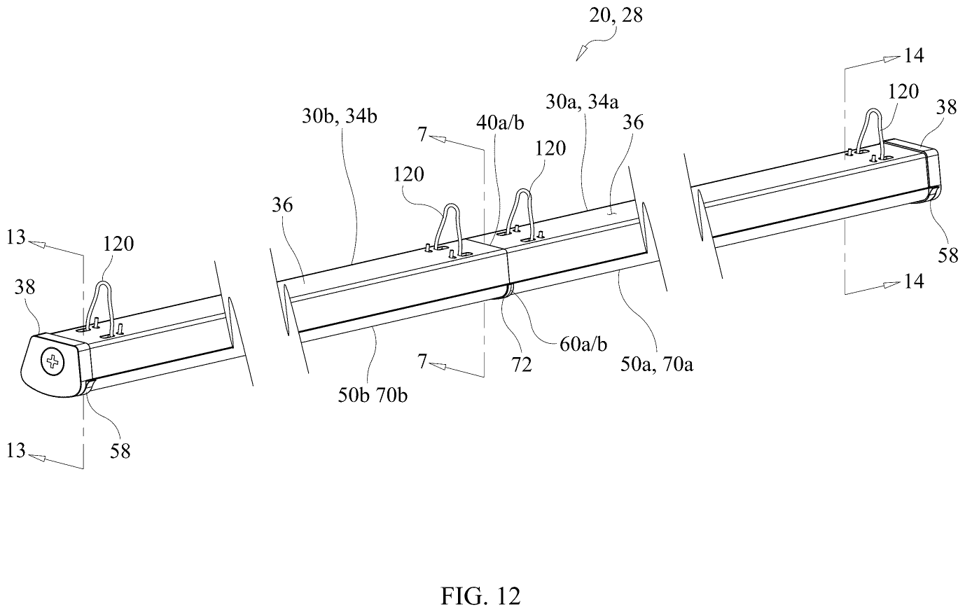

Referring to FIG. 2, an enlarged perspective view of a portion of the lighting fixture 20, each of the first fixture portion 22a and second fixture portion 22b include a housing, which in the illustrative embodiment includes an upper housing 30a/b and lower housing 50a/b. The hinge assembly 90 that couples the first fixture portion 22a and the second fixture portion 22b is coupled to the upper housings 30a/b. Housing hinges 54 rotationally couple the lower housing 50a to upper housing 30a and rotationally couple the lower housing 50b to the upper housing 30b, as best understood from comparing FIG. 5 with FIG. 12. The housing hinges 54 may be living hinges, for example, formed from polypropylene, another polymer, or another flexible material.

The upper housings 30a/b each include an upper housing support 32, a fixture cover 34a/b, and an upper housing end cap 38 at opposite ends, shown in FIG. 1. In the folded position 22 shown in FIG. 1, the entire second fixture portion 22b overlies the entire first fixture portion 22a, and top surfaces 36 (best shown in FIGS. 3 and 4) of fixture covers 34a and 34b abut along a portion or the entire length of the covers 34a/b, or the top surfaces 36 of fixtures covers 34a and 34b are closely adjacent to one another, as can be appreciated from FIGS. 1 and 2. The upper and lower housing supports 32 and 52 may serve as a chassis and a firebox for an electrical light emitter driver (not shown) and thus be formed from sheet metal such as cold rolled steel, or another rigid, fire resistant material that also provides structural rigidity for the lighting fixture 20. The fixture covers 34a/b and upper housing end caps 38 may be formed from a plastic or a composite material, including sustainable plastics.

The lower housings 50a/b each include a lower housing support 52, a lens 70a/b, an emitter board 80, for example a printed circuit board with light emitters 82, and lower housing end caps 58. Advantageously, in the extended position 28 of the lighting fixture 20, the lenses 70a and 70b abut one another and are in alignment to form a continuous illuminated surface between the two lower housing end caps 58 with no gaps or breaks allowing light leakage from the emitter boards 80 around the lenses 70a/b and no encumbrances preventing light transmission from the emitter boards through the lenses. The lower housing end caps 58 may be formed from a plastic or a composite material, including sustainable plastics. The lenses 70a/b may be formed from a transparent thermoplastic such as polycarbonate or acrylic such as PMMA, or another suitable optical material, particularly materials that enable a minimal Unified Glare Rating (UGR), including texture and incorporating internal prism features as shown in FIG. 2.

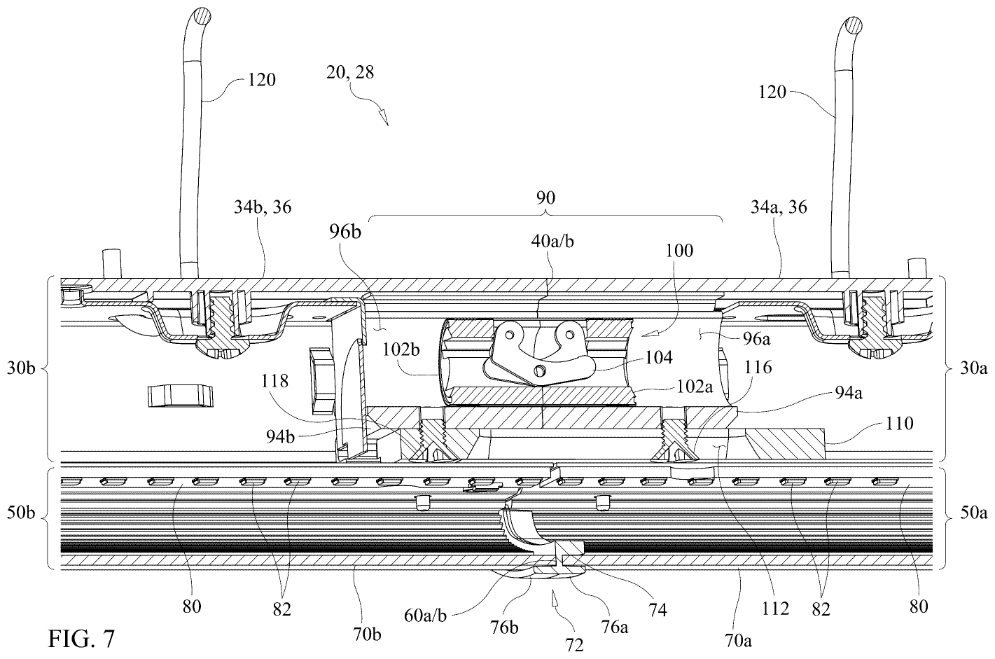

Referring to FIGS. 2 and 7, the hinge assembly 90 includes a first support 94a secured to the upper housing support 32 of the first upper housing 30a, a second support 94b secured to the upper housing support 32 of the second upper housing 30b, a concealed hinge 100 coupled to each of the first and second supports 94a/b, and a brace 110 that provides locking of the hinge assembly 90 in the extended position 28 of the lighting fixture. The first and second supports 94a/b may be formed from a rigid material, for example, but not limited to, a metal or metal alloy, for example aluminum or an aluminum alloy. The supports 94a/b may be extruded, and each define a mortise 96a/b for receiving and anchoring a tenon 102a/b portion of the hinge 100 and also each define a receiver 98a/b for receiving a portion of the brace 110.

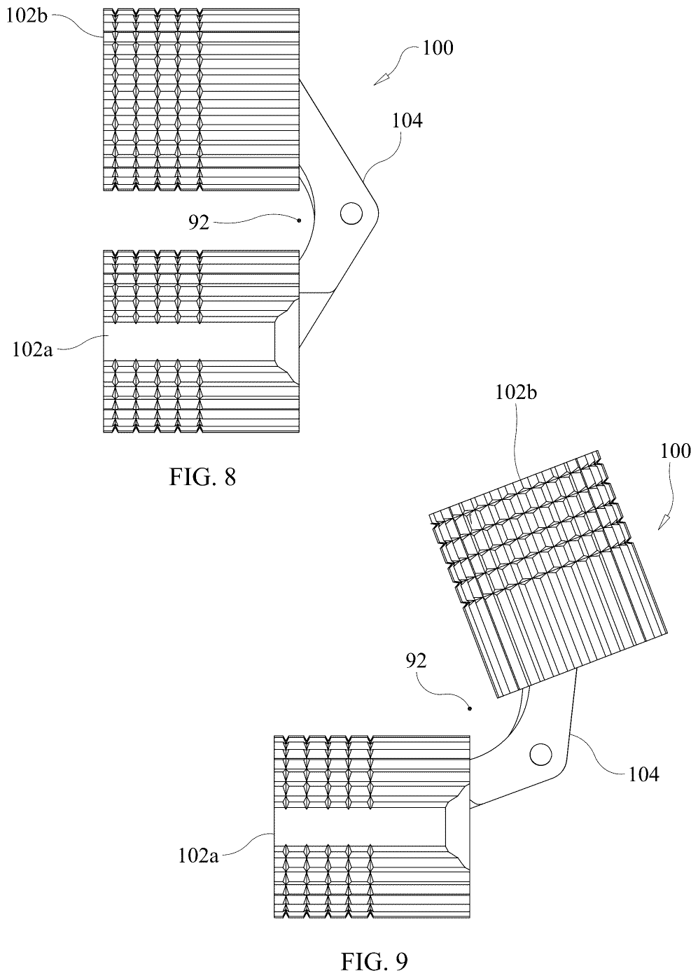

In the illustrative embodiment, the hinge 100 is a type of mortise concealed hinge known as a barrel hinge of the type most known for hinging doors or other moving parts of wood cabinets and other wood products. Referring to FIGS. 8-11, a barrel hinge has the advantage that each of the barrel shaped tenons 102a/b moves on the connecting hinge leaves 104 such that a second tenon 102b will rotate 180 degrees about an axis of rotation 92 (a z-axis) from a position immediately above the first tenon 102a (FIGS. 2 and 8) and move obliquely (within the x- and y-axis) to a position in alignment with and abutting the first tenon 102a (FIGS. 7 and 11).

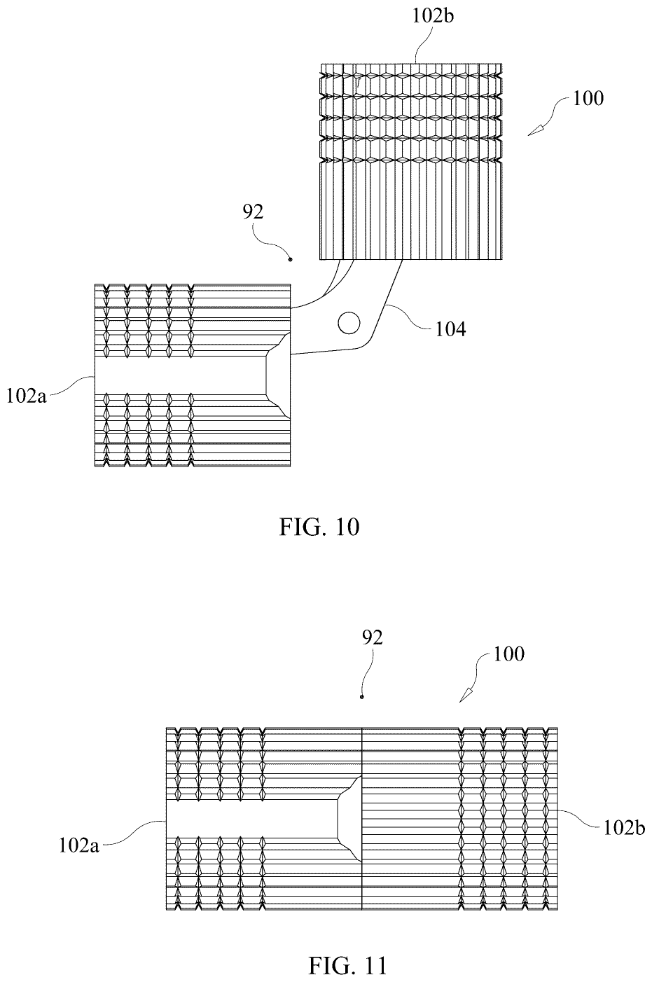

Internally (not shown) the barrel tenons define slots that the ends of the leaves 104 pivot in and translate along, and the leaves 104 and their connections to tenons 102a/b provide a mechanical linkage arrangement such that when the barrel tenon 102b is rotated from the position shown in FIG. 8, through the intermediate transit positions shown in FIGS. 9 and 10, to the position shown in FIG. 11, in which the lighting fixture is in the extended position 28, the leaves 104 pull adjacent ends of the tenons 102a and 102b together until they firmly abut when the tenons 102a and 102b are in alignment as shown in FIGS. 7 and 11. I.e., the motion of the tenons 102a and 102b is mechanically linked in two axes by the linkage relationship formed by leaves 104 and tenons 102a/b such that any rotational motion of tenon 102b about a z-axis requires corresponding motion of tenon 102b in the x- and y-axes, thereby providing the singular path and range of relative motion of tenons 102a and 102b illustrated by FIGS. 8-11.

The mortises 96a/b, for example, extruded cylindrical bores, may be sized to be a press or slip fit for the tensons 102a/b so that the hinge 100 may be easily placed into position within the supports 94a/b prior to anchoring. While the tenons 102a/b of the concealed hinge 100 may be anchored in each mortise 96a/b using various means known in the art, for example, including with bonding glue, welds, or fasteners, the illustrated embodiment uses the technique most typical of barrel hinges in which tightening a screw or other actuator on each tenon 102a/b expands a portion of the diameter of each tenon such that the tenon becomes an interference fit with the mortises 96a/b and is therefore firmly anchored within the supports 94a/b. The hinge 100 may be formed from brass or another alloy, for example, a steel alloy.

Referring to FIGS. 2 and 5, a block 110 is illustrated in FIG. 2 in a position extending from first receiver 98a of the first support 94a of first fixture portion 22a for illustrative purposes. Rotating lower housings 50a and 50b open relative to upper housings 30a and 30b as shown in FIG. 5 provides access to the block 110 and supports 94a and 94b. Closure devices such as spring latches 62 that detent within latch receivers 64 can be included to hold the lower housings 50a and 50b in the closed positions shown in FIGS. 1-4, and can be overcome by applying a slight force on an edge opposite hinges 54 to separate and rotate downward lower housing 50a from upper housing 30a and lower housing 50b from upper housing 30b.

The receivers 98a/b each may be, for example, facing elongate flanges that slidingly retain the block 110 with the supports 94a/b. Prior to moving the lighting fixture 20 from the folded position 24 (FIG. 2) to the extended position 28 (FIGS. 4 and 5), the block 110 must first be slid fully within receiver 98a, for example as shown in FIG. 5, so that it does not block first joining ends 40a and 60a of the first fixture portion 22a from coming into contact with and abutting corresponding joining ends 40b and 60b of the second fixture portion 22b, as shown in FIG. 5. Advantageously, the block 110 may define a slot 112 and be retained to support 94a by retainer 116, for example, a fastener such as a flat head screw as illustrated, while also being free to slide within receiver 98 a distance limited by the slot 112 and retainer 116. The block 114 may also further include stops 114 that additionally or alternative limit travel of the block relative to the receiver 98a.

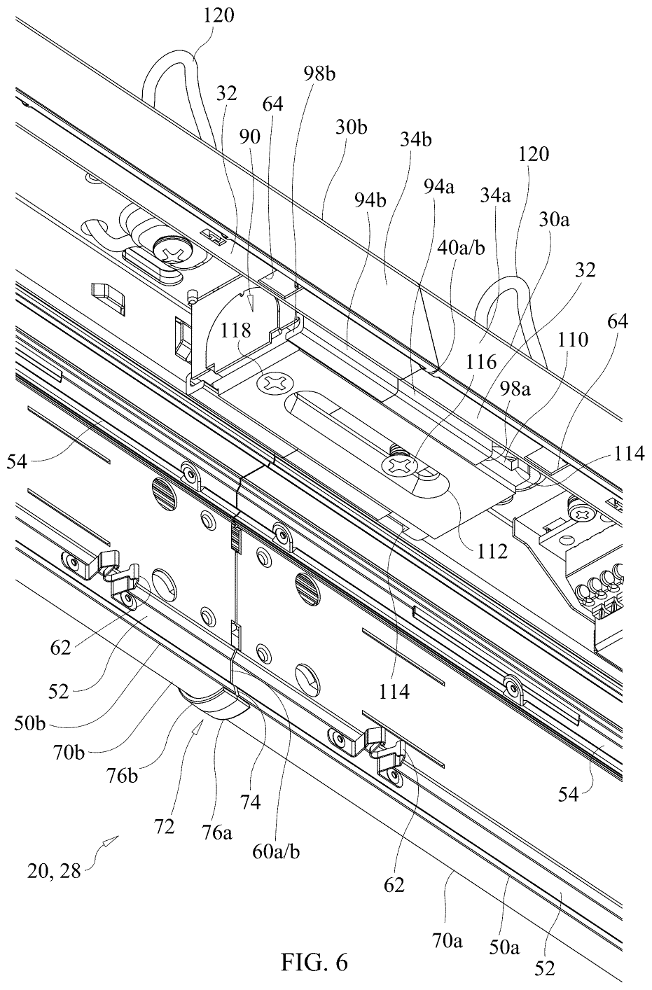

Once the block 110 slides within retainer 98a of support 94a, then the second fixture portion 22b can be rotated 180 degrees to be aligned with first fixture portion 22a, placing supports 94a and 94b into abutting alignment, and thus aligning retainer 98b of support 94b with retainer 98a of support 94a. Once retainers 98a and 98b are aligned, the block 110 is then slid to a position as shown in FIG. 6 in which the block 110 spans both supports 94a and 94b and can be locked into that position, for example, with a fastener 118 that anchors the block to support 94b. In this locked position, the hinge assembly 90 is fixed into position and prevents the lighting fixture 20 from being translated out of the extended position 28. More specifically, as discussed above for concealed hinge 100, because the relative motions of rotation (about the z-axis) and separation from abutting of the hinge (motion in x- and y axis) are mechanically linked, with relative rotation of tenons 102a/b of the hinge prevented by block 110 extending within retainers 98a/b of supports 94a/b, the tenons 102a/b are also prevented from separating, thus holding into abutment the lower joining ends 60a and 60b of the lower housings 50a and 50b, and holding into abutment the upper joining ends 40a and 40b of the upper housings 30a and 30b, for example, as shown in FIG. 7.

Referring to FIG. 2, and to FIG. 7, a cross-sectional view of the lighting fixture of FIG. 1 taken along sectional cutting plane line 7-7, shown in FIG. 12, the upper joining edges 40a and 40b and lower joining edges 60a and 60b are shown held in abutment in the extended position 28 by the locking of the hinge assembly 90 discussed above. One challenge overcome by features of the present disclosure is preventing a gap or other optical feature at the junction of the lenses 70a and 70b that allow light leakage around the lenses, hot spots, and the like from the light emitters 82, for example, LEDs. And in achieving a uniform light transmission from lenses 70a and 70b, including across the junction of 70a and 70b, the features of the present disclosure also prevent any encumbrances that limit or otherwise perceptibly alter the light transmission at the junction of lenses 70a and 70b, for example, dim or dark spots.

In the illustrative embodiment shown in FIGS. 2 and 7, the lens 70a includes a gap diffuser 72 that ensures uniform light transmission across the lenses 70a and 70b, including across the junction of the lenses 70a and 70b, thus forming a continuous illumination surface. The gap diffuser 72 can be formed from a suitable optically transmissive material to provide matching light transmissivity through gap diffuser 72 as from the other portions of lenses 70a and 70b. In the illustrative embodiment of the lighting fixture 20, the gap diffuser 72 if formed from an optical grade silicone selected to match lenses 70a and 70b in visual appearance of light transmission. The gap diffuser 72 may include a first portion that overlies an interior portion of lens 70a and an end of lens 70a, thus forming the first lower joining end 60a of the lens 70a. The gap diffuser 72 may also optionally include portion 76a that overlies an exterior portion of an end of lens 70a and portion 76b that overlies an exterior portion of an end of lens 70b adjacent second lower joining end 60b.

As understood from FIG. 2, the gap diffuser 72 can be formed as a continuing portion of lens 70a or can be separately formed and coupled to lens 70a as is illustrated in FIGS. 2 and 7. Also as illustrated in FIG. 2, the gap diffuser 72 is releasably coupled with lens 70b when the lens 70a and 70b are positioned together, for example, coplanar in the extended position to form a continuous illumination surface as is shown in FIG. 7, i.e., meaning that the full length of the lenses 70a and 70b, including across gap diffuser 72, provide no visually perceptible variance in light illumination from the light emitters 82 when installed at standard ceiling height, whether flush mounted upon top surface 36 or suspended by optional hooks 120. The lenses 70a and 70b together thus visually appear to provide a single, seamless luminous aperture.

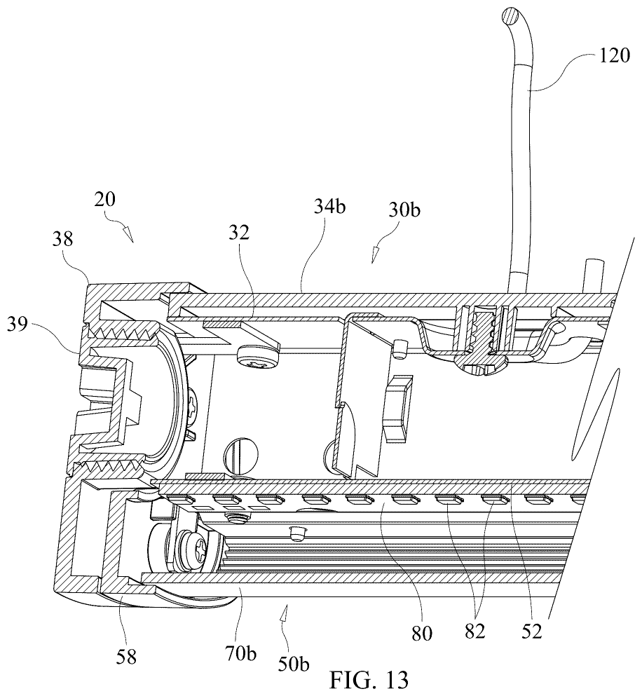

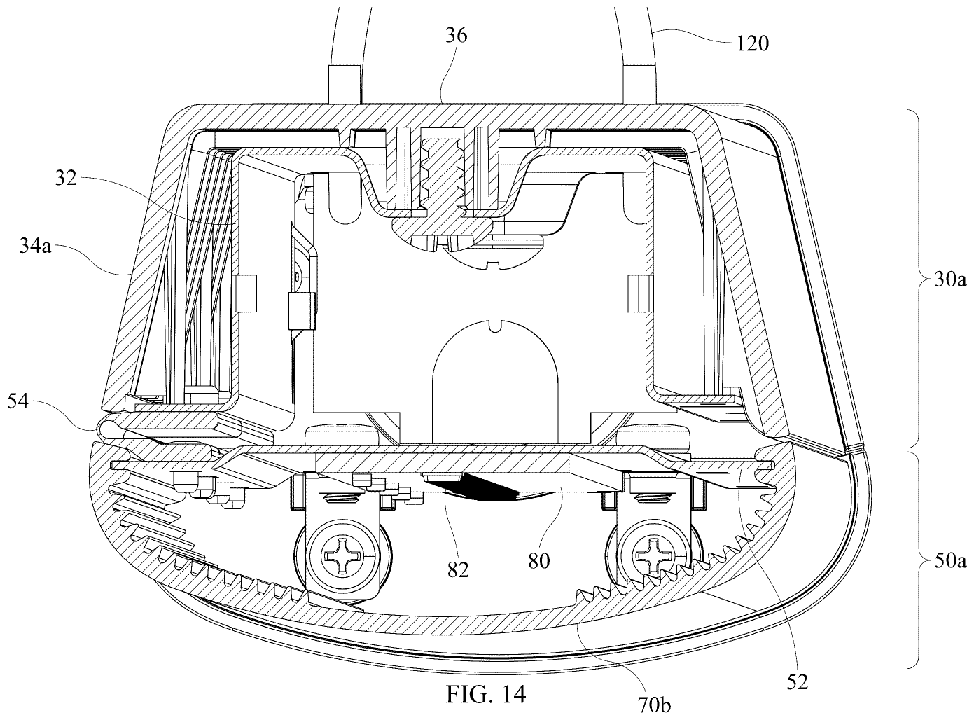

Referring to FIG. 13, a cross-sectional view of a first end of the lighting fixture of FIG. 1 taken along sectional cutting plane line 13-13, shown in FIG. 12, and referring to FIG. 14, a cross-sectional view of a second end of the lighting fixture of FIG. 1 taken along sectional cutting plane line 14-14, shown in FIG. 12, the mechanical assembly of the lower housings 50a/b includes lenses 70a/b, lower housing supports 52, emitter board 80, and the upper housings 30a/b includes upper housing supports 32, covers 34a/b, top surfaces 36, and housing hinges 54 as is further illustrated and appreciated in FIGS. 13 and 14. Upper housing endcap 38, including accessory plug 39 is illustrated in FIG. 13, including its mechanical interaction with lower housing endcap 58 that enables the opening of the lower housings 50a/b relative to upper housings 30a/b while preventing any light leakage around lenses 70a and 70b in the closed position.

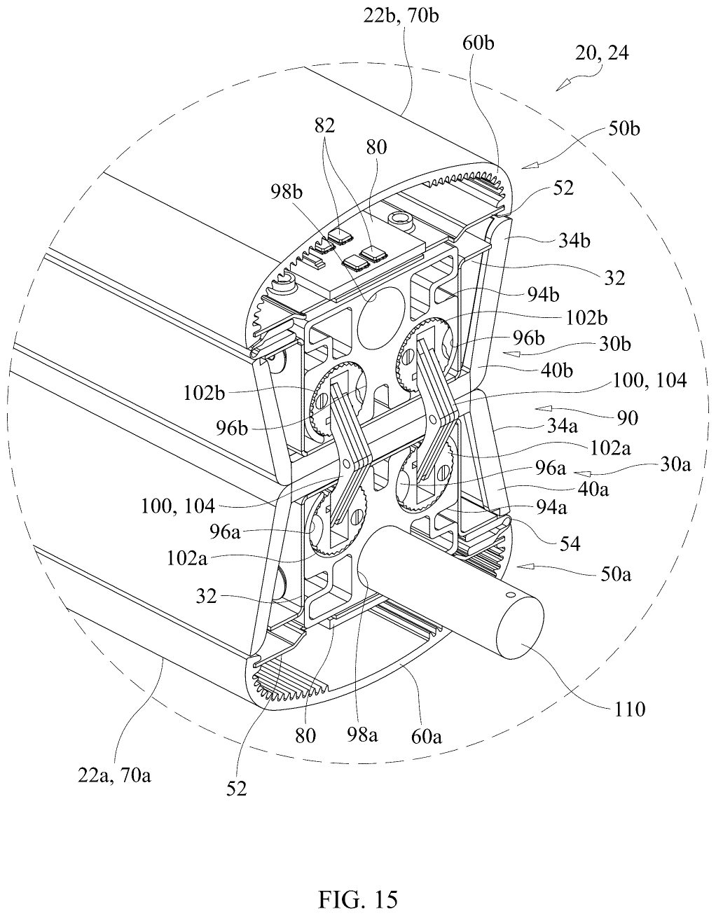

Referring to FIG. 15, an enlarged view of a portion of a second illustrative embodiment of an elongate lighting fixture according to the instant disclosure is shown. The enlarged view illustrates the same enlarged portion as that shown in FIG. 2 for the first illustrative embodiment of FIG. 1. As noted from the illustration, the second illustrative embodiment includes a pair of barrel mortise type concealed hinges 100 and a cylindrical rather than a rectangular shaped block 110 is received by cylindrical receivers 98a/b to lock the hinge assembly 90 in the extended position. Additionally, the optional gap diffuser 72 is absent from the second illustrative embodiment with the lower joining ends 60a/60b providing a sufficiently abutting joint to form a continuous illumination surface, including across the junction of lenses 70a/b with no visually perceptible variance in light illumination from the light emitters 82 when installed at standard ceiling height, whether flush mounted upon top surface 36 or suspended by optional hooks 120, thus appearing to provide a single, seamless luminous aperture.

Any references to benefits or advantages provided by some embodiments may not be included for other embodiments, and other embodiments may include different benefits or advantages. Any benefits or advantages described herein are not to be construed as limiting to any of the claims.

While examples, one or more representative embodiments and specific forms of the disclosure have been illustrated and described in detail in the drawings and foregoing description, the same is to be considered as illustrative and not restrictive or limiting. The description of particular features in one embodiment does not imply that those particular features are necessarily limited to that one embodiment. Some or all of the features of one embodiment can be used or applied in combination with some or all of the features of other embodiments unless otherwise indicated. One or more exemplary embodiments have been shown and described, and all changes and modifications that come within the spirit of the disclosure are desired to be protected.

### Element Numbering

Table 1 includes element numbers and at least one word used to describe the member and/or feature represented by the element number. It is understood that none of the embodiments disclosed herein are limited to these descriptions, other words may be used in the description or claims to describe a similar member and/or feature, and these element numbers can be described by other words that would be understood by a person of ordinary skill reading and reviewing this disclosure in its entirety.

TABLE 1

| | |
|---|---|
| 20 | lighting fixture |
| 22a/b | first/second fixture portion |
| 24 | folded position |
| 26 | transit position |
| 28 | extended position |
| 30a/b | first/second upper housing |
| 32 | upper housing support |
| 34a/b | first/second fixture cover |
| 36 | top surface |
| 38 | upper housing end cap |
| 39 | accessory plug |
| 40a/b | first/second upper joining end |
| 50a/b | first/second lower housing |
| 52 | lower housing support |
| 54 | housing hinge |
| 56 | opening tab |
| 58 | lower housing end cap |
| 60a/b | first/second lower joining end |
| 62 | spring latch |
| 64 | latch receiver |
| 70a/b | first/second lens |
| 72 | gap diffuser |
| 74 | first portion of gap diffuser |
| 76a/b | second portion of gap diffuser |
| 80 | emitter board |
| 82 | light emitters |
| 90 | hinge assembly |
| 92 | axis of rotation |
| 94a/b | first/second support |
| 96a/b | first/second mortise |
| 98a/b | first/second receiver |
| 100 | concealed hinge |
| 102a/b | first/second tenon |
| 104 | hinge leaves |
| 110 | brace |
| 112 | slot |
| 114 | stop |
| 116 | retainer |
| 118 | fastener |
| 120 | hanger |

1. An elongate lighting fixture, comprising:
a first fixture portion including a first plurality of light emitters and a first lens covering the first plurality of light emitters;
a second fixture portion including a second plurality of light emitters and a second lens covering the second plurality of light emitters; and
a hinge assembly rotatably coupling the first and second fixture portions for movement between a folded position and an extended position; and
wherein:
the first fixture portion defines a first joining end adjacent the hinge assembly;
the second fixture portion defines a second joining end adjacent the hinge assembly;
in the folded position the first fixture portion overlies the second fixture portion and the first and second fixture portions remain coupled by the hinge assembly; and
in the extended position the first joining end abuts the second joining end and the hinge assembly is concealed by the first and second fixture portions.

2. The elongate lighting fixture of claim 1, wherein:
the first fixture portion defines a first top surface on a side opposite the first lens;
the second fixture portion defines a second top surface on a side opposite the second lens; and
in the folded position the first top surface abuts the second top surface.

3. The elongate lighting fixture of claim 1, wherein in the extended position the first lens is coplanar with the second lens.

4. The elongate lighting fixture of claim 1, wherein in the extended position the first lens and the second lens form a continuous illumination surface.

5. The elongate lighting fixture of claim 1, wherein in the extended position a first joining end of the first lens is optically transmissive and abuts a second joining end of the second lens that is also optically transmissive.

6. The elongate lighting fixture of claim 1, wherein:
the first lens includes a gap diffuser at a first joining end; and
in the extended position a first portion of the gap diffuser abuts a second joining end of the second lens.

7. The elongate lighting fixture of claim 6, wherein in the extended position a second portion of the gap diffuser overlaps the second joining end of the second lens.

8. The elongate lighting fixture of claim 1, wherein the hinge assembly includes:
a first support coupled to the first fixture portion;
a second support coupled to the second fixture portion; and
at least one hinge coupling the first support to the second support.

9. The elongate lighting fixture of claim 8, wherein:
the first support defines a first hinge mortise;
the second support defines a second hinge mortise; and
the at least one hinge includes a barrel mortise hinge anchored within the first hinge mortise and the second hinge mortise.

10. The elongate lighting fixture of claim 1, wherein the lighting fixture is configured to enable locking the first and second fixture portions in the extended position.

11. The elongate lighting fixture of claim 1, wherein the hinge assembly is configured to enable locking the hinge assembly thereby fixing the first and second fixture portions in the extended position.

12. The elongate lighting fixture of claim 11, wherein the hinge assembly includes:
a first support coupled to the first fixture portion;
a second support coupled to the second fixture portion; and
a brace releasably coupled to at least one of the first support and the second support to lock the hinge assembly.

13. The elongate lighting fixture of claim 12, wherein:
the first support defines a first receiver;
the second support defines a second receiver; and
the brace is received by the first receiver and the second receiver to lock the hinge assembly.

14. The elongate lighting fixture of claim 1, wherein:
the first fixture portion includes a first upper housing and a first lower housing;
the second fixture portion includes a second upper housing and a second lower housing;
the hinge assembly is coupled to the first and second upper housings; and
the first and second lower housings include the respective first and second pluralities of light emitters and the respective first and second lenses.

15. The elongate lighting fixture of claim 14, wherein:
the first fixture portion includes a first housing hinge rotatably coupling the first lower housing to the first upper housing; and
the second fixture portion includes a second housing hinge rotatably coupling the second lower housing to the second upper housing; and
at least one of the first and second lower housings rotated to an open position relative to the first and second upper housings provides access to lock the hinge assembly, thereby retaining the first and second fixture portions in the extended position.

16. An elongate lighting fixture, comprising:
a first fixture portion including a first plurality of light emitters and a first lens covering the first plurality of light emitters;
a second fixture portion including a second plurality of light emitters and a second lens covering the second plurality of light emitters; and
a hinge assembly rotatably coupling the first and second fixture portions for movement between a folded position and an extended position; and
wherein:
the first fixture portion defines a first top surface on a side opposite the first lens and further defines a first joining end adjacent the hinge assembly;
the second fixture portion defines a second top surface on a side opposite the second lens and further defines a second joining end adjacent the hinge assembly;
in the folded position the first top surface overlies the second top surface and the first and second fixture portions remain coupled by the hinge assembly; and
in the extended position a first joining end of the first lens abuts a second joining end of the second lens to form a continuous illumination surface.

17. The elongate lighting fixture of claim 16, wherein in the extended position the hinge assembly is concealed by the first and second fixture portions.

18. The elongate lighting fixture of claim 17, wherein:
the first lens includes a gap diffuser at the first joining end; and
in the extended position a first portion of the gap diffuser abuts the second joining end of the second lens.

19. The elongate lighting fixture of claim 16, wherein the hinge assembly is configured to enable locking the hinge assembly thereby fixing the first and second fixture portions in the extended position.

20. The elongate lighting fixture of claim 19, wherein the hinge assembly includes:
a first support coupled to the first fixture portion;
a second support coupled to the second fixture portion; and
at least one hinge coupling the first support to the second support.

21. The elongate lighting fixture of claim 20, wherein the at least one hinge is a barrel mortise hinge.

22. The elongate lighting fixture of claim 20, wherein the hinge assembly includes a brace releasably coupled to at least one of the first support and the second support to lock the hinge assembly.

23. An elongate lighting fixture, comprising:
a first fixture portion including a first plurality of light emitters and a first lens covering the first plurality of light emitters;
a second fixture portion including a second plurality of light emitters and a second lens covering the second plurality of light emitters; and
a first support coupled to the first fixture portion;
a second support coupled to the second fixture portion; and
at least one hinge coupling the first support to the second support for movement of the first and second fixture portions between a folded position and an extended position; and
wherein:
in the folded position the first fixture portion overlies the second fixture portion and the first and second fixture portions remain coupled by the at least one hinge; and
in the extended position a first joining end of the first lens abuts a second joining end of the second lens.

24. The elongate lighting fixture of claim 23, wherein the at least one hinge is concealed by the first and second fixture portions in the extended position.
